(19) United States
(12) Patent Application Publication
(10) Pub. No.: US 2025/0241352 A1
(43) Pub. Date: Jul. 31, 2025

(54) COFFEE ROASTING SYSTEM HAVING A REMOVABLE VESSEL WITH A RESIDUAL CHAFF CHAMBER AND RESIDUAL WATER CHAMBER

(71) Applicant: Bellwether Coffee Co., Berkeley, CA (US)

(72) Inventors: Stewart SCHMEHL, Pinehurst, NC (US); Peter SCHMEHL, Berkeley, CA (US); Jasvir SANDHU, Boulder, CO (US)

(21) Appl. No.: 18/429,293

(22) Filed: Jan. 31, 2024

(51) Int. Cl. A23N 12/12; A23N 12/08; B04C 9/00

(52) U.S. Cl. CPC A23N 12/125; A23N 12/083; B04C 9/00; B04C 2009/002; B04C 2009/005

(57) ABSTRACT

A bean roasting system includes a removable vessel, a roasting drum, and air handling system, a roasted bean container, an air outlet conduit, a coupling, an air exit subsystem, and a fluid conduit. The removable vessel includes a residual chaff chamber and a residual water chamber fluidically isolated from each other by an inner wall. The roasted bean container is configured to receive roasted beans from the roasting chamber. The air outlet conduit couples the roasting drum to a chaff separator. The coupling couples the chaff separator to the residual chaff chamber of the removable vessel. The air exit subsystem removes exhaust air from the air exit subsystem and/or roasted bean container. The fluid conduit routes condensed water from the air exit subsystem to the residual water chamber of the removable vessel.

### CROSS REFERENCE TO RELATED PATENT APPLICATION

The present application is related to the patent application entitled “Coffee Roasting System Having an Agitator Blade Set with a Minimum Air Gap”, having application Ser. No. ______ [Attorney Docket No. BWCC-012/00US], and filed herewith, the contents of which are incorporated herein in its entirety.

### FIELD

The present disclosure pertains to the roasting of food products, particularly to beans, and more particularly to coffee beans. Yet more particularly, the present disclosure describes a roasting system design that reduces maintenance requirements.

### BACKGROUND

Food roasting machines are in wide use. Some known roasting machines prepare coffee beans to be either packaged or ground and brewed. One challenge with such known roasting systems is the generation of different waste streams-chaff and waste water-generated during roasting and cooling beans.

### SUMMARY

In an aspect of the disclosure, a bean roasting system includes a removable vessel, a roasting drum, an air handling system, a roasted bean container, an air outlet conduit, a coupling, an air exit subsystem, and a fluid conduit. The removable vessel includes a residual chaff chamber and a residual water chamber fluidically isolated from each other by an inner wall. The roasted bean container is configured to receive roasted beans from the roasting chamber. The air outlet conduit couples the roasting drum to a chaff separator. The coupling couples the chaff separator to the residual chaff chamber of the removable vessel. The air exit subsystem removes exhaust air from the air handling system and/or the roasted bean container. The fluid conduit routes condensed water from the air exit subsystem to the residual water chamber of the removable vessel. Having one removable vessel for both chaff and water reduces maintenance intervention for a roasting system.

A method comprises operating a roasting drum of a bean roasting system to roast a batch of beans. The bean roasting system further includes a removable vessel, an air handling system and an air exit subsystem. The removable vessel includes a residual chaff chamber and a residual water chamber isolated from each other by a wall disposed between the residual chaff chamber and the residual water chamber. The method further comprises operating an air handling system to heat and circulate air through the roasting drum and to remove residual chaff from the air being circulated. The method also comprises routing the residual chaff from the air handling system to the residual chaff chamber, routing air from the air handling system through the air exit subsystem, removing condensed water from the air passing through the air exit subsystem, and routing the condensed water to the residual water chamber.

### BRIEF DESCRIPTION OF THE FIGURES

FIG. 1 is a schematic diagram of an embodiment of a roasting system for processing a batch of coffee beans.

FIG. 2 is a simplified electrical block diagram for the roasting system of FIG. 1.

FIG. 3 is an isometric view of an embodiment of a roasting system.

FIG. 4 is a cutaway view of a portion of a roasting system of FIG. 3, with respect to the roasting drum agitation.

FIG. 5 is an isometric view of an embodiment of a residual chaff and water collection vessel.

FIG. 6 is a cross-sectional view of the residual chaff and water collection vessel taken along line 6-6 in FIG. 5.

### DETAILED DESCRIPTION

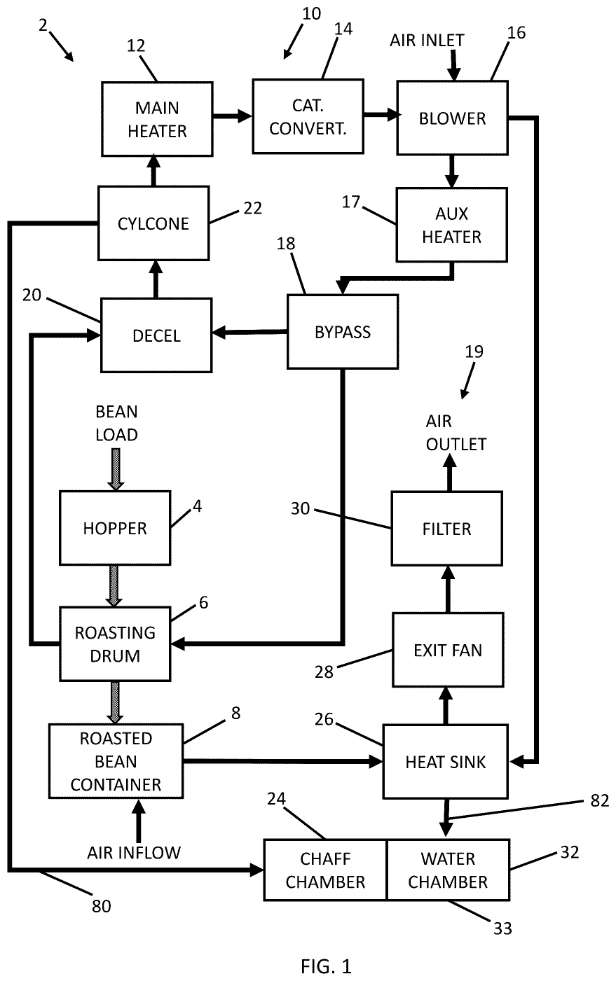

FIG. 1 is a schematic diagram of an embodiment of a roasting system 2. FIG. 1 discloses fluid paths between various components of the roasting system 2. In other words, various components of the roasting system 2 are fluidically coupled along the fluid paths. The fluid paths tend to conduct gaseous fluids such as air, water vapor, and gaseous emissions from beans being roasted or cooled. In addition, particulates from the roasting process such as chaff can also be transmitted or entrained through the fluid paths. FIG. 1 also discloses a path for a batch of beans from a bean load to a bean exit.

Roasting system 2 includes a hopper 4 for loading and receiving a quantity or batch of unroasted beans. The hopper 4 feeds into a roasting drum 6 (also referred to herein as “roasting subsystem 6”) within which the batch of beans is heated and roasted according to, for example, a pre-programmed roasting process. Adjacent or below the roasting drum 6 is a roasted bean container 8 (also referred to herein as “bean cooler 8”) for receiving the batch of beans from the roasting drum 6 after they are roasted.

The roasting drum 6 is coupled to an air handling system 10 that includes a main heater 12, a catalytic converter 14, a blower 16, an optional auxiliary heater 17, a bypass 18, a velocity decelerator 20, a cyclone separator 22, and chaff collector or chamber 24. The air handling system 10 determines a temperature versus time roasting profile through controlled operation of the main heater 12, blower 16, optional auxiliary heater 17, bypass 18, and possibly other components of air handling system 10. An air stream (indicated by arrows) recirculates through the air handling system 10. The air handling system 10 receives and removes particles and gaseous effluents emitted during the roasting process. The particles are captured by the cyclone 22 which deposits them in the chaff collector 24 (as referred to herein as “chamber 24”) via coupling 80. The gaseous effluents are collected by the catalytic converter 14. The auxiliary heater 17 is described as optional because it is likely included within higher capacity roasting systems but not within smaller capacity roasting systems.

The air handling system 10 defines two different branches of air flow that is coupled by the bypass 18. One branch circulates from the bypass 18 to a decelerator 20, through the cyclone 22, main heater 12, catalytic converter 14, blower 16, and optional auxiliary heater 17, before returning to the bypass 18. Another loop passes from the bypass 18 to the roasting drum 6, to the decelerator 20, and back to the bypass 18 without entering the cyclone 22.

Part of an airstream generated by the blower 16 passes through an air exit subsystem 19 (also referred to herein as “exit airstream”). The air exit subsystem 19 includes a heat sink 26, an exit fan 28, and a filter 30 before being passed to environmental air. The heat sink 26 has the effect of condensing water vapor from the exit airstream as well as cooling the exit airstream. The condensed water vapor is transferred by fluid conduit 82 to a water collection chamber 32 (also referred to herein as “water collection receptable 32”). For example, the fluid conduit 82 can be a flexible silicon tube that includes a first portion with a p-trap to create a water barrier (to prevent air ingress back to the heat sink 26) and a second portion allows residual water to drain into the water chamber 28. The top end of the fluid conduit 82 can be, for example, above the bottom end of the fluid conduit 82 (e.g., one inch above) to allow for gravitational drainage of the residual water into the water chamber 32. Replacement air from the environment air enters the blower 16 at an air inlet of blower 16. The overall effect is to remove water vapor from the air handling system 10 and to condense the water vapor into water for collection in the water collection chamber 32.

The bean cooler 8 is also fluidically coupled to the air exit subsystem 19 via heat sink 26. The exit fan 28 therefore draws air out of the bean cooler 8 through the heat sink 26. This has the effect of accelerating cooling of the batch of beans located in the bean cooler 8.

The chaff chamber 24 and water chamber 32 are collectively formed into a residual chaff and water collection vessel 33. Having a single collection vessel 33 for chaff and water reduces maintenance intervention for roasting system 2. Moreover, having the chaffer chamber 24 and water chamber 32 fluidically separated also reduces difficulty of removing and disposing of the chaff and water. For example, where it is desirable to dispose of the chaff in one location and dispose of the water in a different location, it is advantageous to have the chaff chamber 24 and water chamber 32 fluidically separated.

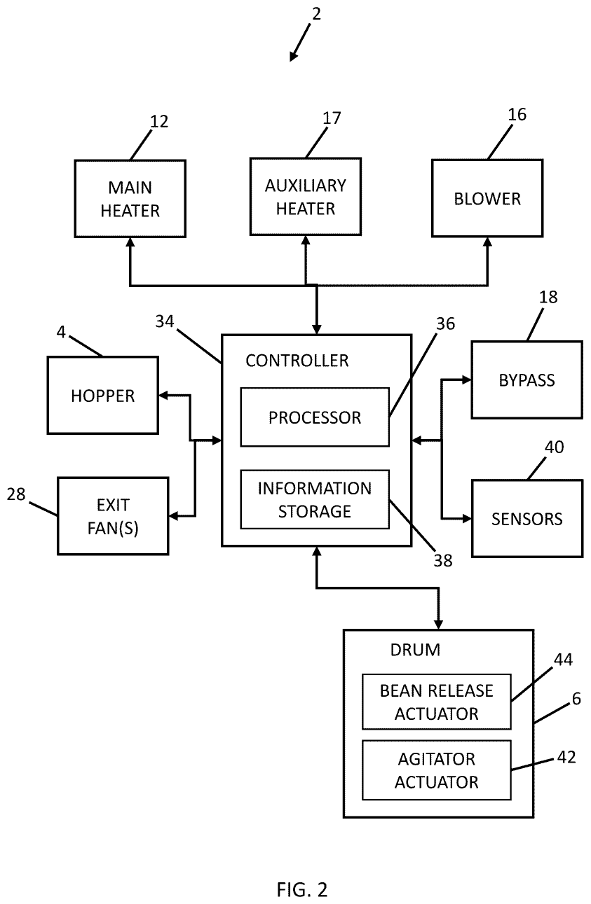

FIG. 2 is a simplified electrical block diagram of the roasting system 2. Relative to FIG. 1, like element numbers refer to like components. In contrast to FIG. 1, which focuses on fluidics and the physical motion of beans, FIG. 2 focuses on electrical or wireless connections between components. In other words, the components of roasting system 2 shown in FIG. 2 are electrically coupled and/or communicatively coupled, either through wired connections or wireless connections.

A controller 34 includes a processor 36 coupled to an information storage device 38 (e.g., a memory). The information storage device 38 (also referred to herein as “memory 38”) can be, for example, a non-volatile or non-transient information storage device 38 that stores software instructions. The processor 36 executing the software instructions can control portions of the roasting system 2 that the controller 34 is configured to control. For example, the controller 34 can be configured to control the hopper 4, drum 6, bean cooler 8, main heater 12, blower 16, auxiliary heater 17, bypass 18, exit fan 28, and/or other portions of the roasting system 2. The controller 34 can receive information from one or more sensors 40 for monitoring a status of portions of roasting system 2. The sensors 40 can include, for example, a temperature sensor, a humidity sensor, etc.

Processor 36 can be, for example, a hardware-based integrated circuit (IC) or any other suitable processing device configured to run and/or execute a set of software instructions or code. For example, processor 36 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, processor 36 can be configured to run any of the methods and/or portions of methods discussed herein.

Memory 38 can be, for example, a random-access memory (RAM), a memory buffer, a hard drive, a read-only memory (ROM), an erasable programmable read-only memory (EPROM), and/or the like. Memory 38 can be configured to store any data used by processor 36 to perform the techniques (methods, processes, etc.) discussed herein. In some instances, memory 36 can store, for example, one or more software programs and/or code that can include instructions to cause processor 36 to perform one or more processes, functions, and/or the like. In some implementations, memory 38 can include extendible storage units that can be added and used incrementally. In some implementations, memory 38 can be a portable memory (for example, a flash drive, a portable hard disk, a SD card, and/or the like) that can be operatively coupled to processor 36. In some instances, memory 38 can be remotely operatively coupled with a compute device (not shown in FIG. 2).

The controller 34 can also be configured to control various actuators including for example an agitator actuator 42 and a bean release actuator 44 associated with the drum 6. The agitator actuator 42 is configured to agitate the batch of beans within the drum 6 during the roasting process. The bean release actuator 44 is configured to release the batch of beans from drum 6 after roasting so that the batch of beans can enter the bean cooler 8.

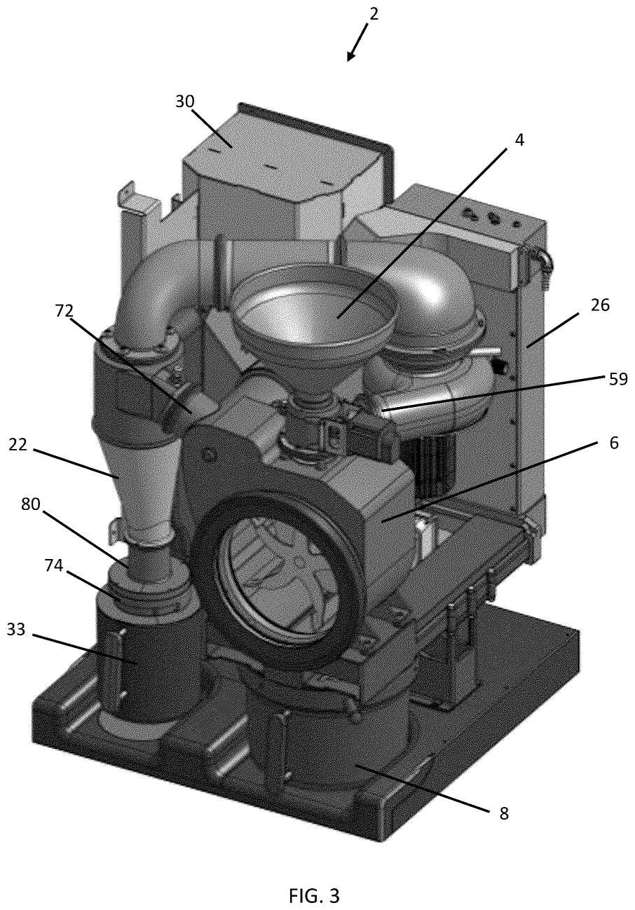

FIG. 3 is an isometric view of a roasting system 2 with certain components such as an outer housing removed. Relative to FIG. 1, like element numbers indicate like components.

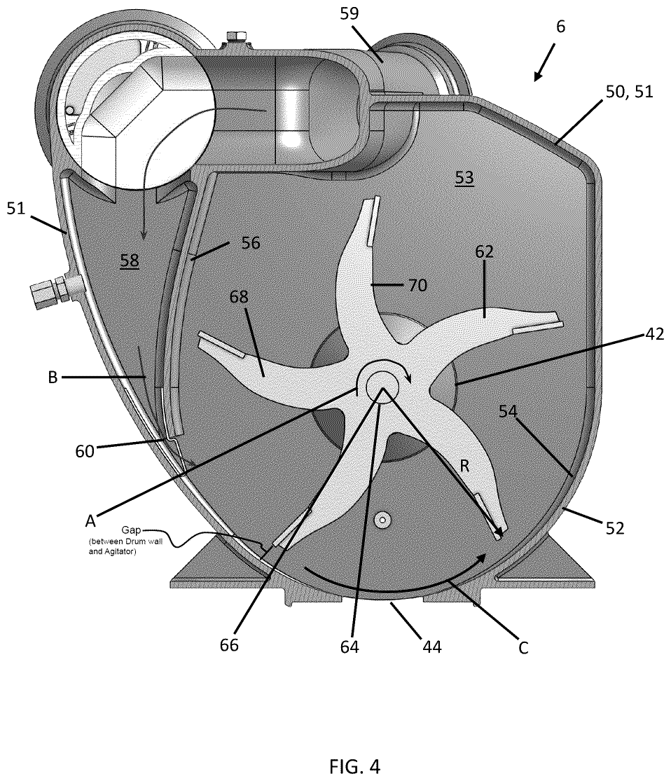

FIG. 4 is a cutaway view of the roasting drum 6 of FIG. 3. The roasting drum 6 includes a housing 50 including an outer wall 51 and surrounding a roasting chamber 53. The housing 50 includes a curved lower wall 52 that defines a curved inner surface 54. The housing 50 also includes an inner extension wall 56. Between a portion of the outer wall 51 (shown on the upper left side in FIG. 4) and inner extension wall 56 is an air inlet chamber 58. In other words, the portion of the outer wall 51 and the inner extension wall 56 collectively define in part an air inlet chamber 58. The air inlet chamber 58 tapers or narrows to a jet impinging outlet 60. The drum includes an inlet conduit 59.

Roasting drum 6 contains an agitator blade set 62 that is coupled to an axle 64 having an axis of rotation 66. The axle 64 is coupled to agitator actuator 42, which can be for example a motor having an output shaft coupled to (or formed with) the axle 64. The agitator blade set 62 includes a plurality of blades 68 that each extend radially to a distance R from the center of rotation 66. The curved inner surface 54 (or the curved lower wall 52) is a distance of R+G from the axis of rotation 66, which rotates in a rotational direction A during the roasting process. Thus, a gap of magnitude G is present between the distal end of each blade 68 and the curved inner surface 54 of the curved lower wall 52. In other words, each blade from the agitator blade set 62 has a distal end disposed from the axis of rotation 66 by a at least a first distance (e.g., a maximum distance R) and spaced from the curved lower wall 52 (or curved inner surface 54) by at least a second distance (e.g., a minimum distance G)

Each blade 68 has an arcuate shape (from the view shown in FIG. 4) having a concave side 70 that faces a direction of rotation A. In an illustrative embodiment, the value of G is in a range of 0.25 to 0.75 inch or about 0.50 inch. For example, the value of G can be 0.47 inches; for such an embodiment the value of R can be 4.44 inches. In the illustrative embodiment, the plurality of blades 68 includes five blades 68 but in other embodiments a different number of blades is possible.

Although each blade from the plurality of blades 68 is shown in FIG. 4 as having a common length, in other embodiments, one or more blades from the plurality of blades can have a different length from the remaining one or more blades from the plurality of blades. For example, when the plurality of blades includes five blades, one blade can be longer than the remaining four blades.

Although the plurality of blades 68 are shown in FIG. 4 as being monolithically formed along with the remaining portion of the agitator blade set 62, in other embodiment, one or more blades from the plurality of blades can be formed separately from one or more blades from the plurality of blades and/or the remaining portion of the agitator blade set.

During a roasting process, heated air enters the inlet conduit 59 and passes to the inlet chamber 58. The velocity of the air increases as it converges in a downward direction B through the inlet chamber 58 and to the “jet impinging outlet” or impinging outlet 60. Air passing from the impinging outlet 60 circulates between the agitator blade set 62 and the curved inner surface 54 in a first rotational direction C. This is illustrated in the example of FIG. 4 as counterclockwise. At the same time, the actuator motor 42 rotates the agitator blade set 62 in a second rotational direction A. This is illustrated in the example of FIG. 4 as clockwise. The second rotational direction A is opposite to the first rotational direction C. The opposing rotational directions provides a very effective agitation of the beans during roasting. For example, to the extent that the rotating agitator blade set 62 does not agitate beans within the gap (between the distal end of each blade 68 and the curved inner surface 54 of the curved lower wall 52), the air exiting from impinging outlet 60 and rotating in the first rotational direction C agitates at least those beans.

In one or more configurations, the angular velocity of the rotating agitator blade set 62 and the airflow rate have a predefined relationship to achieve a desirable level of agitation of beans in the gap during roasting within the drum 6 (e.g., adequately agitate the beans in the gap such that beans do not over-roast by remaining on the curved inner surface 54 too long). The appropriate angular velocity of the rotating agitator blade set 62 and the airflow rate to achieve a desirable level of agitation of beans in the gap during roasting can vary as a function of the size of the drum 6. For example, in one or more configurations, the angular velocity of the rotating agitator blade set 62 can be 71 rotations per minute (RPM), and the airflow rate can be 30% to 100% of maximum possible airflow. In other configurations, the angular velocity of the rotating agitator blade set 62 can be 40 RMP, 50 RMP, 60 RMP, 80 RMP, 90 RMP, 100 RMP, any value in between. The volume of the airflow out of the jet impinger 60 can be, for example, about 250 cubic feet/minute (CFM) and 7 cubic meters/minute. The cross-sectional area of the opening of the jet impinger 60 can be, for example, 1260 squared millimeters (or 0.00126 square meters), resulting in an air velocity out of the opening of the jet impinger 60 can be, for example, 93 meters/second. In other configurations, the volume of the airflow out of the jet impinger 60 can be, for example, about 200, 225, 275, 300 cubic feet/minute (CFM) or any value in between, where the angular velocity of the rotating agitator blade set 62 is selected to achieve a desirable level of agitation of beans in the gap during roasting depending on the size of the drum. Similarly in other configures, the air velocity out of the opening of the jet impinger 60 can be, for example 70 m/s, 80 m/s, 90 m/s, 100 m/s, 110 m/s, 120 m/s and any value in between, where the angular velocity of the rotating agitator blade set 62 is selected to achieve a desirable level of agitation of beans in the gap during roasting depending on the size of the drum.

In sum, in one or more embodiments, the angular velocity of the rotating agitator blade set and the airflow rate have values, depending on the size of the drum, to adequately agitate the beans in the gap such that beans do not over-roast by remaining on the curved inner surface too long. For example, if the airflow is below a certain level (e.g., 30% of maximum possible airflow), then the bean agitation efficiency could be undesirably reduced. Similarly, blade motion that is too slow could be undesirably reduce the amount of lofting of the beans to obtain desired convection and consistency. But, if the airflow is too high, the reducing of the convective energy after the first crack of beans during the roasting process (e.g., when the specific heat of the beans is dramatically reduced) is negatively impacted.

The sequence of selecting the angular velocity of the rotating agitator blade set and the airflow rate can be described as follows. First, the size of roasting chamber can be selected (or determined) by load capacity of the roaster. Second, maximum airflow capacity is determined by targets for roasting performance as they relate to rate of rise and roast time for a full load of beans to be roasted to a dark roast in an amount of time commensurate with high quality coffee. For example, getting to a dark roast of over 460 F in eleven minutes or less can provide a desirable roast result. A centrifugal blower, for example, with a 300 W motor can generate airflows consistent with a 3 or 4 pound bean load, which can be an appropriate minimum in a commercial setting.

Third, once the maximum airflow is determined, it is possible to determine heater power. Three considerations exit. The first consideration is to ensure that a reasonable pre-heat time can be achieved. Typically preheat times of approximately ½ hour are consistent with use case and customer acceptance. The second consideration is to ensure that there is enough heater power to generate drum inlet temperatures during roasting that provide enough head-room to get to dark roasts. Dark roasts are typically 460 F so an inlet temperature of 590 F is desired. Making the inlet temperature more than this is counterproductive as it can lead to bean surface ignition. During lighter roasts, it is possible to set inlet temperature lower than 590 F, but typically it is not set lower than 550 F. The third consideration for heater power is to ensure that total system power is still within the realm of electrical power that is generally available in retail coffee shop settings. This range is typically 6 KW (240V/24 A) to 10 KW (240V/40 A). So in one implementation, the heater power can be 4 KW.

Fourth, once airflow is known and reasonable heater power established, it is possible to select (or design) an inlet nozzle that provides desired agitation to the agitator blades to be spaced away from the inner surface of the roasting drum. The minimum gap of the blade from the roasting drum inner surface should be sufficient to clear the largest green coffee bean that may be present in a batch, depending on what types of coffee are to be roasted. Making the gap much bigger than this does not provide any advantage, and so the gap size is primarily selected (determined) by the target bean size. It is advantageous to not make the gap so big as to result in a very high agitation airflow from the nozzle to compensate for the large gap size. Restricting the dimensions of the nozzle adversely increases the backpressure that the main recirculating blower should overcome, which is not desirable as the increased backpressure increases the size of the blower and motor that drives it. Hence, a minimal but effective agitator spacing is desired. Making the gap smaller than the ideal will have the undesirable impact of crushing beans and at some point scraping against the sidewall of the drum, resulting in honing of the drum's surface to a precision diameter, which can increase cost of both the drum and the agitator.

For a very large roaster, a very high rate of airflow will be desired from the blower so the nozzle geometry may be larger and the target air speed higher than for a smaller roaster. For very large roasters, it may be desirable to have a slightly larger agitator spacing to ensure that the fabrication of the drum and agitator can be held to tolerances that promote ease of manufacturing and reduce cost.

As best illustrated in FIG. 3, air exits the roasting chamber 53 through an air outlet conduit 72 and passes to velocity decelerator 20 and then to cyclone separator 22. The cyclone separator 22 can also be referred to as a “chaff separator” 22, which may have additional or modified components beyond those described herein or shown in FIGS. 1-6.

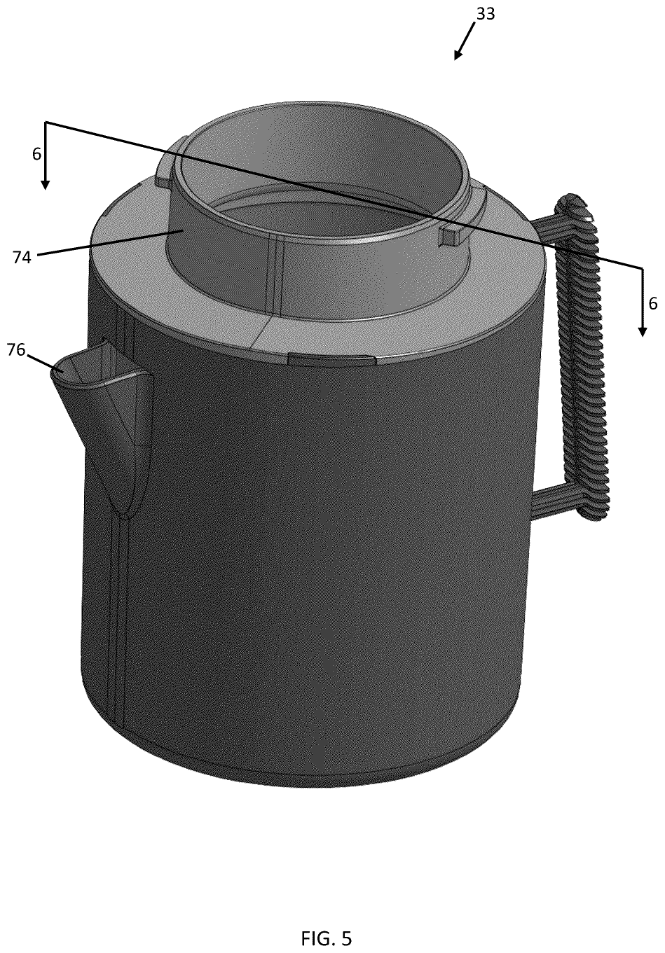

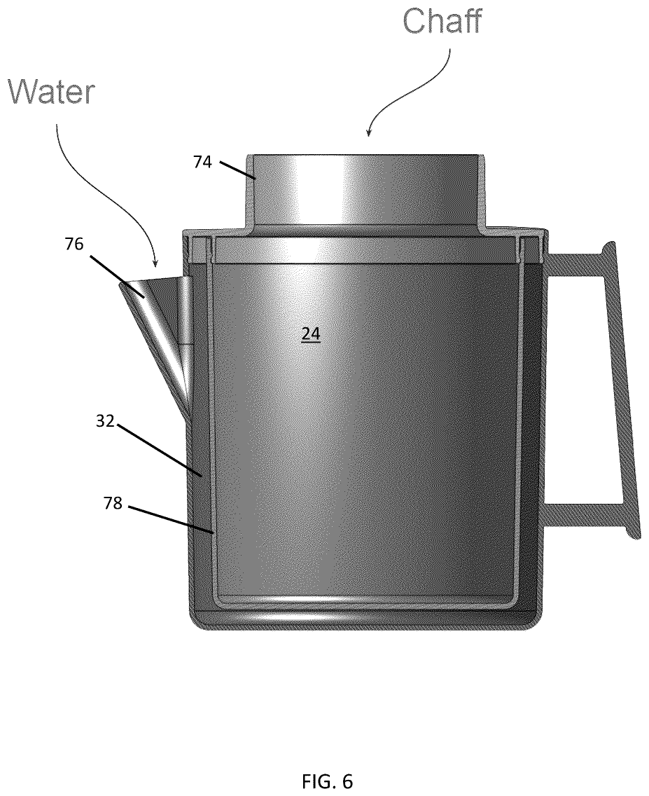

FIG. 5 is an isometric drawing of the residual chaff and water collection vessel 33. Vessel 33 includes a upper and central chaff inlet 74 (also referred to herein as a “port” or a “chaff port”) for receiving residual chaff from the cyclone separator 22. Vessel 33 also has a water inlet 76 (also referred to herein as a “port” or a “water port”) for receiving residual water from the heat sink 26. The vessel 33 can be removably coupled to the bean roaster to allow for the collection of residual chaff and residual chaff during the roasting operation. Once the roasting operation is complete, the vessel 33 can be removed from the bean roasting (i.e., no longer coupled to the bean roaster) to allow for the residual chaff and the residual water to be expelled from the vessel 33. Thus, the chaff port 74 and the water port 76 are used to both receive and expel residual chaff and residual water, respectively. As shown in FIGS. 5 and 6, the chaff port 74 has a non-zero height and disposed above the planar portion of the lid of the vessel 33; the water port 76 is shaped as a spout that is disposed on a portion of the side wall of the vessel 33. Although shown with these particular sizes and shapes, it should be understood that a chaff port and water port can have different sizes, shapes and/or locations to allow for the residual chaff and the residual water to be expelled from the vessel 33 separately. For example, it may be desirable for the chaff port to have a greater height on the side proximate to the water port so that the residual water can be expelled from the water chamber without the residual chaff being expelled from the chaff chamber, as described further below.

FIG. 6 is a cross-sectional view of the residual chaff and water collection vessel 33 taken along line 6-6 in FIG. 5. As shown, the chaff chamber 24 and water chamber 32 are separated by an inner wall 78 (also referred to herein as a “wall” or a “first wall”). The vessel 33 also includes an outer wall (also referred to herein as a “wall” or a “second wall”). The water chamber 32 is defined as the chamber between the inner wall 78 and the outer water. In other words, the water chamber 32 is disposed between the inner wall 78 and the outer wall. The inner wall 78 (as well as the water chamber 32 and the outer wall) is disposed circumferentially about the chaff chamber 24. In other words, the inner wall 78 (as well as the water chamber 32 and the outer wall) surrounds the chaff chamber 24 along the vertical sides and the bottom side of vessel 33. Said yet another way, the inner wall 78 is disposed between the chaff chamber 24 and the water chamber 32.

A coupling 80 (FIGS. 1, 3) fluidically couples the cyclone or chaff separator 22 of the air handling system 10 to the chaff chamber 24, when the vessel 33 is coupled to the bean roaster (also referred to herein as a “first position”). For example, the chaff chamber 24 is fluidically coupled to the air handling system 10, when the vessel 33 is coupled to the bean roaster (in the first position). A fluid conduit 82 (FIG. 1) fluidically couples the heat sink 26 of the air exit subsystem 19 to the water chamber 32, when the vessel 33 is coupled to the bean roaster (in the first position). For example, the water chamber 32 is fluidically coupled to the air exit subsystem 19, when the vessel 33 is coupled to the bean roaster (in the first position).

The vessel 33 can also be removed from the bean roaster (also referred to herein as a “second position”). The vessel 33 can be removed from the bean roaster, for example, after the roasting process is completed and the residual water and residual chaff are to be expelled from the vessel 33 and discarded (e.g., in a water receptacle such as a sink for the residual water, and a trash receptacle for the residual chaff). The water inlet 76 used to receive residual water from heat sink 26 can also be used to expel the residual water from the water chamber 32 (i.e., act as a water outlet or a port). Similarly, the chaff inlet 74 used to receive residual chaff from cyclone separator 22 can also be used to expel the residual chaff from the chaff chamber 24. In use, the vessel 33, water port 76 and chaff port 74 can be sized and shaped to allow the residual water to be expelled from the water chamber 32 without expelling the residual chaff from the chaff chamber 24. For example, it is possible to tilt the vessel over a water receptacle (such as a sink) to expel the residual water from the water chamber 32 without the residual chaff being expelled from the chaff chamber 24. Alternatively, a temporary cover can be placed over the opening of the chaff port 74 to prevent the residual chaff from leaving the chaff chamber 24 while the residual water is being removed from the water chamber 32 by tilting the vessel.

Combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. As such, all examples and/or embodiments are deemed to be non-limiting throughout this disclosure.

It is to be understood that the logical and/or topological structure of any combination of any program components (a component collection), other components and/or any present feature sets as described in the Figures and/or throughout are not limited to a fixed operating order and/or arrangement, but rather, any disclosed order is an example and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting.

What is claimed:

1. A bean roasting system, comprising:
a removable vessel including a residual chaff chamber and a residual water chamber fluidically isolated from each other by an inner wall;
a roasting drum;
an air handling system configured to heat and circulate air through the roasting drum and to remove residual chaff from the air being circulated;
a coupling that routes the residual chaff to the residual chaff chamber during a roasting process; and
an air exit subsystem that is configured to receive air from the air handling system and to condense water from the air and to deliver resultant residual water to the residual water chamber.

2. The bean roasting system of claim 1, wherein the air handling subsystem includes a cyclone separator, the coupling routes the residual chaff from the cyclone separator to the residual chaff chamber during the roasting process.

3. The bean roasting system of claim 1, wherein:
the bean roasting system further includes a roasted bean container configured to receive roasted beans from the roasting drum,
cooling air from the roasted bean container passes into the air exit subsystem during operation of the bean roasting system, and
the air exit subsystem is configured to condense water from the cooling air and to further deliver resultant residual water to the residual water chamber.

4. The bean roasting system of claim 1, wherein the air exit subsystem includes a heat sink, an exit fan, and a filter through which air passes from the air handling system and the roasted bean container.

5. The bean roasting system of claim 4, further comprising a fluid conduit that directs condensed water from the heat sink to the residual water chamber during operation of the bean roasting system.

6. The bean roasting system of claim 3, wherein the air exit subsystem includes a heat sink, an exit fan, and a filter through which air passes from the air handling system and the roasted bean container.

7. The bean roasting system of claim 6, further comprising a fluid conduit that directs condensed water from the heat sink to the residual water chamber during operation of the bean roasting system.

8. A method, comprising:
operating a roasting drum of a bean roasting system to roast a batch of beans, the bean roasting system further including a removable vessel, an air handling system and an air exit subsystem, the removable vessel including a residual chaff chamber and a residual water chamber isolated from each other by a wall disposed between the residual chaff chamber and the residual water chamber;
operating an air handling system to heat and circulate air through the roasting drum and to remove residual chaff from the air being circulated;
routing the residual chaff from the air handling system to the residual chaff chamber;
routing air from the air handling system through the air exit subsystem;
removing condensed water from the air passing through the air exit subsystem; and
routing the condensed water to the residual water chamber.

9. The method of claim 8, further comprising:
a coupling fluidically coupling the air handling system and the residual chamber,
the air handling subsystem including a cyclone separator,
the coupling routes the residual chaff from the cyclone separator to the residual chaff chamber during the roasting process.

10. The method of claim 8, wherein the bean roasting system further includes a roasted bean container configured to receive roasted beans from the roasting drum,
the method further includes routing air from the roasted bean container through the air exit subsystem.

11. The method of claim 8, wherein the air exit subsystem includes a heat sink, an exit fan, and a filter,
the method further comprising transferring the condensed water from the heat sink to the residual water chamber.

12. The method of claim 8, wherein:
the air exit subsystem includes a heat sink, an exit fan, and a filter, and
the bean roasting system further includes a roasted bean container configured to receive roasted beans from the roasting drum,
the method further comprising:
routing air from the roasted bean container through the air exit subsystem; and
transferring the condensed water from the heat sink to the residual water chamber.

13. The method of claim 8, wherein:
the residual water chamber is disposed circumferentially about and below the residual chaff chamber,
the residual water chamber including a port sized and shaped to be fluidically coupled to the air exit subsystem when the vessel during the roasting process,
the residual chaff chamber including a port sized and shaped to be fluidically coupled to the air handling system during the roasting process.

14. The method of claim 8, wherein:
the vessel has a first position and a second position, the vessel in the first position being coupled to the bean roaster, the vessel in the second position being removed from the bean roaster,
the residual water chamber including a port sized and shaped to be fluidically coupled to the air exit subsystem when the vessel is in the first position,
the residual chaff chamber including a port sized and shaped to be fluidically coupled to the air handling system when the vessel is in the first position,
the port of the residual water chamber configured to expel the residual water when the vessel is in the first position,
the port of the residual chaff chamber configured to expel the residual chaff when the vessel is in the second position.

15. An apparatus, comprising:
a vessel configured to be removably coupled to a bean roaster having (1) a roasting drum, (2) an air handling system configured to heat and circulate air through the roasting drum and to remove residual chaff from the air being circulated, and (3) an air exit subsystem that is configured to receive air from the air handling system and to condense water from the air,
the vessel including a residual chaff chamber and a residual water chamber fluidically isolated from each other by a wall disposed between the residual chaff chamber and the residual water chamber,
the vessel receiving residual chaff into the residual chaff chamber from the air handling system during a roasting process,
the vessel receiving residual water into the residual water chamber from the air exit subsystem during the roasting process.

16. The apparatus of claim 15, wherein the residual water chamber is disposed circumferentially about and below the residual chaff chamber.

17. The apparatus of claim 15, wherein:
the wall is a first wall,
the vessel includes a second wall, the residual water chamber disposed between the second wall and the first wall,
the first wall disposed between the residual chaff chamber and the residual water chamber.

18. The apparatus of claim 15, wherein:
the residual water chamber is disposed circumferentially about and below the residual chaff chamber,
the residual water chamber including a port sized and shaped to be fluidically coupled to the air exit subsystem when the vessel during the roasting process,
the residual chaff chamber including a port sized and shaped to be fluidically coupled to the air handling system during the roasting process.

19. The apparatus of claim 15, wherein:
the vessel has a first position and a second position, the vessel in the first position being coupled to the bean roaster, the vessel in the second position being removed from the bean roaster,
the residual water chamber including a port sized and shaped to be fluidically coupled to the air exit subsystem when the vessel is in the first position,
the residual chaff chamber including a port sized and shaped to be fluidically coupled to the air handling system when the vessel is in the first position,
the port of the residual water chamber configured to expel the residual water when the vessel is in the first position,
the port of the residual chaff chamber configured to expel the residual chaff when the vessel is in the second position.

20. The apparatus of claim 15, wherein:
the vessel has a first position and a second position, the vessel in the first position being coupled to the bean roaster, the vessel in the second position being removed from the bean roaster,
the residual water chamber including a port sized and shaped to be fluidically coupled to the air exit subsystem when the vessel is in the first position,
the residual chaff chamber including a port sized and shaped to be fluidically coupled to the air handling system when the vessel is in the first position,
the port of the residual water chamber configured to expel the residual water without the residual chaff being expelled from the residual chaff chamber, when the vessel is in the first position,
the port of the residual chaff chamber configured to expel the residual chaff when the vessel is in the second position.
